(19) United States
(12) Patent Application Publication
(10) Pub. No.: US 2024/0017217 A1
(43) Pub. Date: Jan. 18, 2024

(54) SPACERS COMPATIBLE WITH ACTIVE LAYER IN FLUID FILTRATION ELEMENTS

(71) Applicant: Aqua Membranes, Inc., Albuquerque, NM (US)

(72) Inventors: Rodney E. Herrington, Albuquerque, NM (US); Kevin Roderick, Albuquerque, NM (US); Jaime Mateus, Cambridge, MA (US)

(21) Appl. No.: 18/359,304

(22) Filed: Jul. 26, 2023

Related U.S. Application Data
(63) Continuation of application No. PCT/US22/15688, filed on Feb. 8, 2022.
(60) Provisional application No. 63/148,002, filed on Feb. 10, 2021.

(51) Int. Cl. B01D 63/10; B01D 71/56; B01D 67/00

(52) U.S. Cl. CPC B01D 63/103; B01D 71/56; B01D 67/0081; B01D 2313/143; B01D 2315/10

(57) ABSTRACT

A spiral wound membrane element comprising feed spacer elements applied to the active polyamide surface of the membrane sheet, where the feed spacer elements comprise similar material as the active polyamide layer.

### TECHNICAL FIELD

The subject invention relates to a membrane system utilized for the separation of fluid components, and especially to cross-flow and spiral-wound membrane elements.

### BACKGROUND ART

In cross-flow filtration, a feed fluid flows through a filter and is released at the other end, while some portion of the fluid is removed by filtration through a membrane surface, which is parallel to the direction of fluid flow. Various forms of cross-flow filtration exist including plate-and-frame, cassette, hollow-fiber, and spiral wound systems. Plate-and-frame, cassette, and spiral-wound filtration modules often rely on stacked membrane layers which provide spacing between adjacent layers of filtration membrane. The present invention is applicable to such systems. Several references are listed herein to facilitate understanding of the invention; each of those references is incorporated herein by reference.

Spiral-wound membrane filtration elements known in the art consist of a laminated structure having a membrane sheet sealed to or around a porous permeate carrier, which creates a path for removal, longitudinally to the axis of the center tube, of the fluid passing through the membrane to a central tube, while this laminated structure is wrapped spirally around the central tube and spaced from itself with a porous feed spacer to allow axial flow of the fluid through the element from the feed end of the element to the reject end. Traditionally, a feed spacer is used to allow flow of the feed water, some portion of which will pass through the membrane, into the spiral wound element and allow reject water to exit the element in a direction parallel to the center tube and axial to the element construction.

Improvements to the design of spiral wound elements have been disclosed in U.S. Pat. No. 6,632,357 to Barger et al., U.S. Pat. No. 7,311,831 to Bradford et al., and patents in Australia (2014223490) and Japan (6499089) entitled “Improved Spiral Wound Element Construction” to Herrington et al. which replaces a conventional feed spacer with islands or protrusions printed, deposited or embossed directly onto the inside or outside surface of the membrane. US patent application PCT/WO2018190937A1 entitled “Graded spacers for filtration wound elements” to Roderick, et al., describes the use of height graded spacer features which are used to alter feed flow characteristics in a spiral wound element. US patent application PCT/US17/62424 entitled “Interference Patterns for Spiral Wound Elements” to Roderick, et al., describes patterns in spiral wound elements that keep membrane feed spaces open but also provide support for the membrane envelope glue areas during rolling. US patent application PCT/US18/55671 entitled “Bridge Support and Reduced Feed Spacers for Spiral-Wound Elements” to Roderick et al. describes support features that are applied to the distal end (farthest end from the center tube) of the membrane envelope to provide support during gluing and rolling of the spiral wound element. US provisional application number 63,051,738 entitled “Variable Velocity Patterns in Cross Flow Filtration” to Herrington et al. describes support patterns that vary in size from the feed to the reject end of the membrane feed space in the feed flow path parallel to the center tube in order to control the velocity of the feed solution as the concentration of the feed solution increases from the feed to the reject end of the spiral wound element. Each of the foregoing is incorporated herein by reference.

Patterns on membrane surfaces utilizing interfacial polymerization are described by Sajjad H. Maruf, et al., entitled “Fabrication and characterization of a surface-patterned thin film composite membrane” and published in the Journal of Membrane Science, 452 (2014) pages 11-19. These patterns have been fabricated for controlling cellular responses for the purpose of biofilm control. Typical groove depths of 200 nano meters are described. These groove depths are much, much smaller than 1 thousandth of an inch.

Printing of a polyamide coating on the polysulfone substrate has been described by Chris Arnush with the Zukerberg Institute of Water Technology of Ben Gurion University in a paper entitled “2-D and 3-D Printing Assisted Fabrication and Modification of UF/NF/RO Membranes for Water Treatment”. Polyamide coatings applied by electrospray have also been described by Jeffery McCutcheon with the University of Connecticut.

### BRIEF SUMMARY OF THE INVENTION

The top selective layer of a membrane is referred to as the active layer. In some embodiments the active layer can comprise polyamide. A typical thin-film composite (TFC) reverse osmosis (RO) membrane is made through interfacial polymerization of polyamide on the surface of a microporous substrate. As a general description, interfacial polymerization of polyamide occurs when an amine solution contacts a chloride solution. There are many possible formulations for specific amine and chloride solutions that can be utilized. In some embodiments the amine solution comprises an aqueous amine solution and the chloride solution comprises an organic chloride solution. In conventional membrane manufacturing a substrate is placed in contact with an amine solution, typically comprising m-phenyldiamine for RO membranes and piperazine for nanofiltration membranes, and subsequently placed in contact with a chloride solution, typically comprising trimesoyl chloride (TMC).

An embodiment of the present invention provides a method of using interfacial polymerization to fabricate feed spacers comprising polyamide on the active layer of a membrane. For example, interfacial polymerization of the feed spacers can be facilitated by printing an aqueous amine solution and printing a chloride solution on to the membrane surface or active layer.

In a specific example embodiment of the current invention, an aqueous amine solution comprising 1,6-hexanediamine can be printed on to the membrane active layer, followed by printing another solution comprising sebacoyl chloride. Other specific example embodiments can utilize different chloride solutions, including solutions comprising TMC, sebacoyl chloride, or any mixture thereof. The chloride solution can also comprise one or more organic solvents. For example, the chloride solution can comprise solvents such as hexane, toluene, or any mixture thereof. Other materials and solutions, now known or later discovered, that create interfacial polymerization reactions can also be utilized.

These spacers are of sufficient height to create the fluid flow space between two membrane sheets in a spiral wound element or flat sheet membrane system. Fluid flow spacer heights can be in the range of 0.001 inch to 0.050 inches, or greater. For thin spacers to maximize the surface area of membrane sheet in a spiral wound element in some applications, spacer heights can be in the range of 0.003 inches to 0.017 inches. For spacer heights to minimize energy losses in some applications from pressure losses from the feed to reject end of the element, spacer heights can be in the range of 0.015 inches to 0.035 inches in height, or greater.

Embodiments of the present invention provide elements for use in fluid filtration comprising a permeable support layer, a selectively permeable active layer applied thereon, and one or more spacing features applied on the active layer. As an example, the spacing features can comprise polyamide feed spacers printed on the membrane active layer. As examples, the spacing features can have the thicknesses and other characteristics described elsewhere herein.

### BRIEF DESCRIPTION OF THE DRAWINGS

FIG. 1 is an exploded view of a spiral wound membrane element.

FIG. 2 is an exploded view of a partially assembled spiral wound membrane element.

FIG. 3 is a cross section view of a membrane sheet with a conventional mesh type feed spacer

FIG. 4 is a cross section view of a membrane sheet with a polyamide thin film layer with polyamide spacer features applied to the surface of the thin film layer.

### MODES FOR CARRYING OUT THE INVENTION AND INDUSTRIAL APPLICABILITY

The feed spacer in a spiral wound filtration element is required to maintain a channel for fluid to flow through, but the spacer design also impacts local flow velocities, turbulence, stagnation zones and other fluid flow conditions. Extruded mesh feed spacers have been used traditionally in membrane manufacture due to their ease of integration in the production process, but by their nature many of their hydrodynamic characteristics are dependent on the thickness of the spacer. Printed feed spacers allow for unique design characteristics unobtainable with conventional extruded or woven mesh spacers, since their thickness and geometry can be changed independently to yield a wide range of configurations which can be tailored to specific applications or specific challenges found in spiral wound membrane element construction.

Cross-flow filtration relies on some portion of the feed fluid to pass through the filter and become part of the filtrate, thus creating a situation where the quantity of the feed fluid is constantly being reduced as it passes through the filter. The higher the portion of filtrate produced, the lower the portion of feed/concentrate fluid that remains flowing through the filter. As a fluid flows through the element, a portion of the fluid passes through the membrane. Modeled simply, a constant flux through the membrane produces a gradually decreasing flow of the feed solution as it flows through the element. In reality the amount of fluid passing through depends on local flow conditions and local concentrations of solutes or suspended materials, as well as the local pressure which also depends on any back-pressure from the permeate side of the element locally.

Many cross-flow filtration systems, such as spiral wound elements and stack filters, rely on parallel flat sheets of membrane material through which the feed fluid flows. In such systems where the feed channel occupies a fixed volume, the loss of feed fluid to the filtrate stream creates a situation where the fluid stream flowing from the feed inlet to the concentrate outlet decreases in cross-flow velocity along the length of the filter, but increases in ion concentration toward the reject end of the fluid stream. Hydrodynamic conditions in the filter, including the cross-flow velocity, as well as the filter geometry and the feed spacer, affect several important characteristics of the fluid flow such as fluid shear, boundary layer thickness, and concentration polarization which in turn affect filter performance characteristics including membrane flux, frictional pressure losses, biological fouling, and scaling. Thus, for a system with a fixed filter geometry and feed spacer, the changing cross-flow velocity induces changes in these characteristics throughout the system, which can lead to less desirable performance.

Embodiments of the present invention provide processes to produce feed spacers wherein the spacer material comprises polyamide and is located on the active layer of membrane sheet. In an example embodiment of the present invention a printing process is used to create polyamide feed spacers on a membrane surface. In one example embodiment the polyamide spacer material is the same or similar to the active layer of a thin film composite membrane sheet. Other embodiments include spacer material comprising of polyamide and other additives, such additives can be added for various purposes including: reducing fouling; improving membrane permeability or rejection performance; modifying physical and chemical spacer properties including surface chemistry, height, stiffness, permeability, porosity, and roughness. Other example embodiments include various layers of spacer material comprising polyamide and one or more materials. By way of a non-limiting example, a spacer can be mostly comprised of polyamide with a top “capping” layer of a different material. Such embodiment can be desirable in order to obtain suitable surface characteristics that allow the various layers in a spiral wound membrane to be rolled while avoiding undesirable interactions between the top of the spacer and any adjacent material.

Spacers constructed of polyamide material provide several benefits relative to those previously known. First, the spacer material does not require application by inkjet type printing, screen printing, or other techniques that utilize ultraviolet (UV) or light in the visible spectrum to cure the spacer material. The use of photopolymer curing can add heat or other forms of energy to the membrane sheet, which can damage the structure of the thin film composite (TFC) and adversely affect the flux or ion rejection characteristics of the membrane sheet. Photopolymer ink jet applied materials can also add organics to the membrane surface thereby reacting with the charged membrane surface which can negatively affect flux or rejection characteristics. Interfacial polymerization as used with example embodiments of the present invention can be accomplished at room temperature by a rapid chemical reaction thereby significantly reducing temperature rise on the TFC. Further, polyamide feed spacers can allow feed solution flow through the physical spacer. This is not possible with materials used in conventional ink jet printers using photopolymer processes. As such, the loss of active membrane surface area will be greater with conventional inkjet spacer materials relative to spacers applied with polyamide material. This feature can enhance permeation rates in membrane systems and improve overall permeate production and efficiency for any given size membrane element or flat sheet membrane system. Furthermore, in embodiments where both the feed spacers and the membrane active layer comprise polyamide, there is less risk of adverse interactions or material incompatibility between the feed spacers and the membrane surface.

The feed spacing features employed can comprise any of a number of shapes, including round dots, ovals, bars with rounded ends, lenticular forms, stretched polygons, lines or other geometric shapes. Due to the shape of the features and the fact that fluid in many cases must traverse around the outside of the features, the fluid flow velocity will change locally in the areas between the feed spacing features, but if the features are uniform in size and pattern, the bulk fluid velocity is only affected by the reduction in fluid volume caused by filtrate flowing through the membrane. The result is a net reduction in fluid volume and therefore fluid velocity from the inlet to the reject stream of the element.

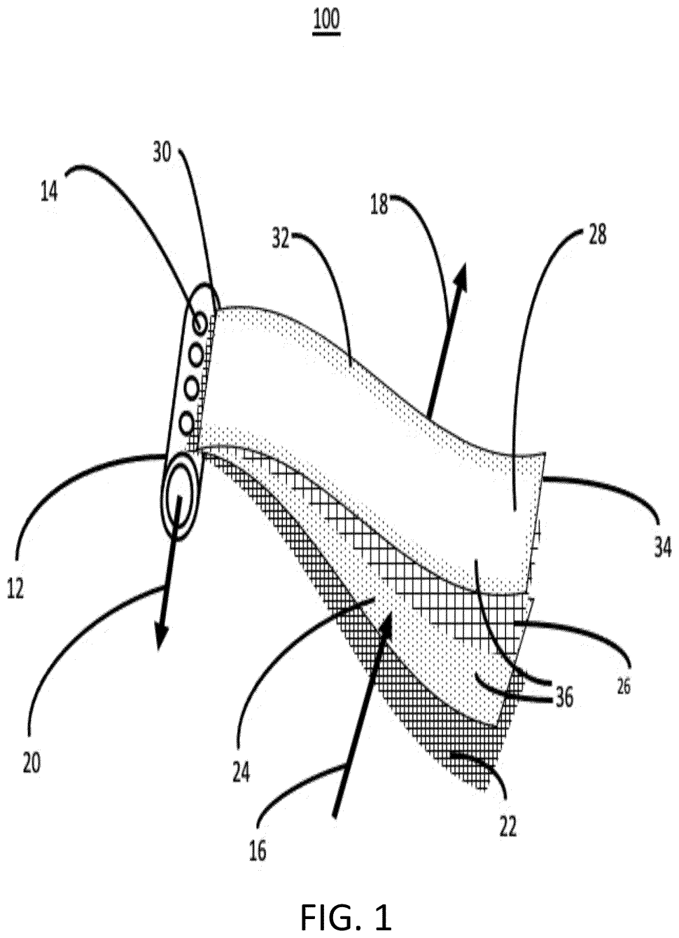

FIG. 1 is a schematic illustration of a conventional spiral wound membrane element prior to rolling, showing important elements of a conventional spiral wound membrane element 100. Permeate collection tube 12 has holes 14 in collection tube 12 where permeate fluid is collected from permeate carrier 22. In fabrication, membrane sheet 36 is a single continuous sheet that is folded at center line 30, comprised of a non-active porous support layer on one face 28, for example polysulfone, and an active polymer membrane layer on the other face 24 bonded or cast on to the support layer. In the assembled element, active polymer membrane surface 24 is adjacent to feed spacer mesh 26, and non-active support layer 28 is adjacent to permeate carrier 22. Feed solution 16 enters between active polymer membrane surfaces 24 and flows through the open spaces in feed spacer mesh 26. As feed solution 16 flows through feed spacer mesh 26, particles, ions, or chemical species, which are excluded by the membrane are rejected at active polymer membrane surfaces 24, and molecules of permeate fluid, for instance water molecules, pass through active polymer membrane surfaces 24 and enter porous permeate carrier 22. As feed solution 16 passes along active polymer membrane surface 24, the concentration of materials excluded by the membrane increases due to the loss of permeate fluid in bulk feed solution 16, and this concentrated fluid exits the reject end of active polymer membrane sheet 24 as reject solution 18. Permeate fluid in permeate carrier 22 flows from distal end 34 of permeate carrier 22 in the direction of center tube 12 where the permeate fluid enters center tube 12 through center tube entrance holes 14 and exits center tube 12 as permeate solution 20. To avoid contamination of the permeate fluid with feed solution 16, non-active polymer membrane layers 28 are sealed with adhesive along adhesive line 32 through permeate carrier 22 thereby creating a sealed membrane envelope where the only exit path for permeate solution 20 is through center tube 12. Typically, the width of the adhesive line 32 is 1-3″ after the adhesive has been compressed during the rolling process.

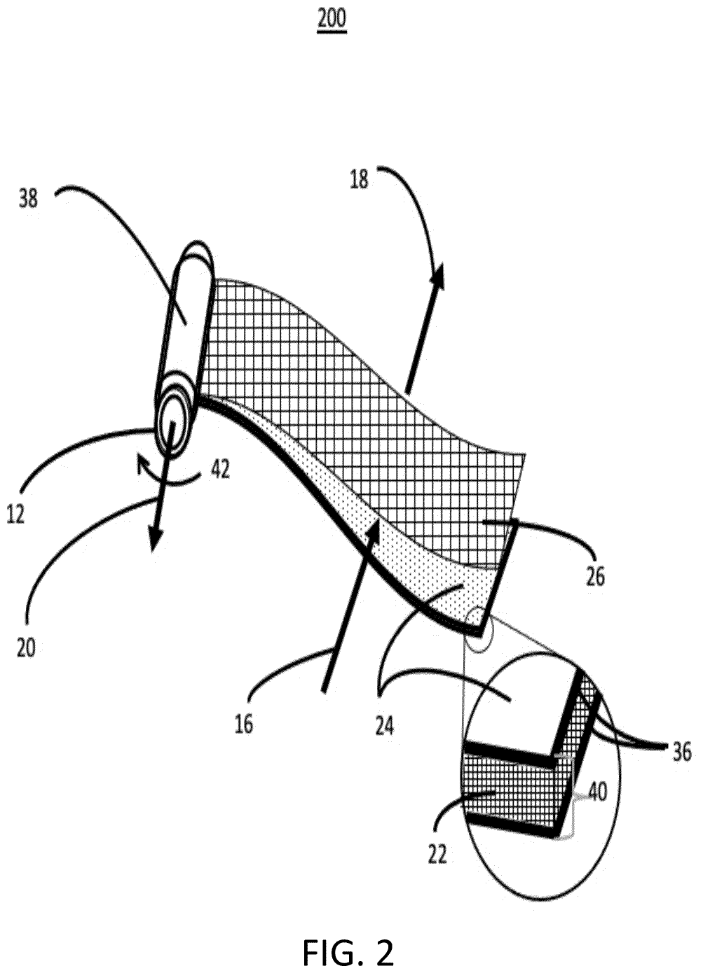

A partially assembled spiral wound membrane element 200 is shown in FIG. 2. A membrane envelope 40 comprises, as described in connection with FIG. 1, a membrane sheet 36 folded at one end with a permeate carrier 22 disposed therebetween the membrane sheet and sealed along the edges with a suitable adhesive. In the conventional design of membrane element once rolled, a feed spacer mesh 26 is placed adjacent to envelope 40 to allow the flow of feed fluid 16 to flow between layers membrane envelope 40 and expose all of the active polymer surfaces 24 of the membrane sheet to feed fluid. Permeate, or product fluid is collected in the permeate carrier 22 inside membrane envelope 40 and proceeds spirally down to center tube 12 where the product, or permeate fluid is collected while the reject stream 18 exits the element. A single spiral wound element may comprise a single membrane envelope and feed spacer layer, or may comprise multiple membrane envelopes and feed spacer layers stacked and rolled together to form the element.

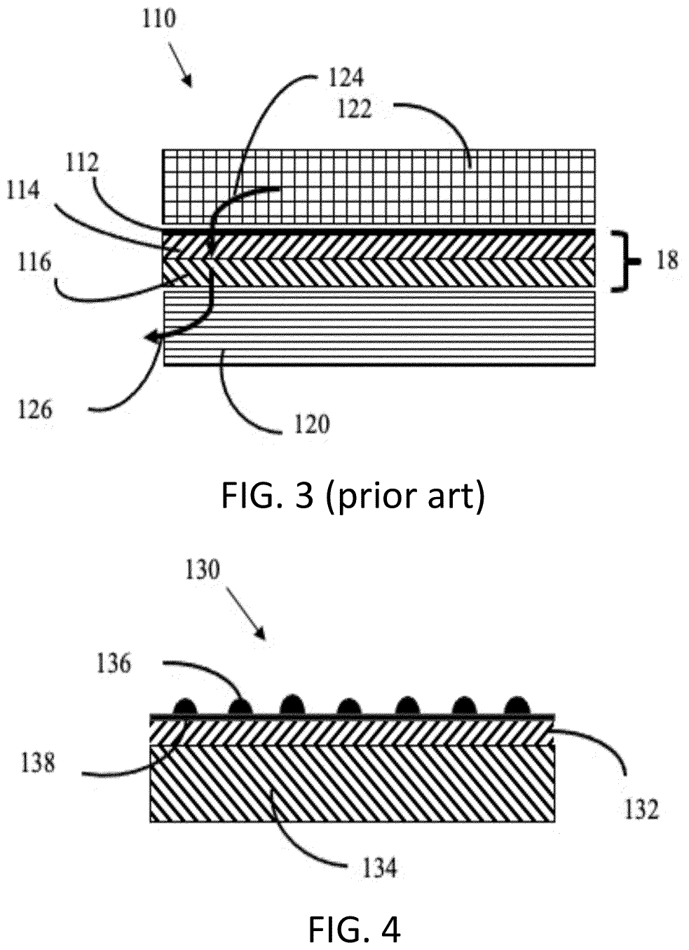

In a representative embodiment of an existing reverse osmosis spiral wound membrane elements shown in FIG. 3, spiral wound element composite layers 110 comprise a membrane sheet assembly 118 comprising a porous polyethylene layer 116, for example, bonded to a porous polysulfone layer 114, for example, and coated with a cast-in-place polymer membrane layer 112. In order for feed water to be distributed evenly to polymer membrane layer 112, feed spacer mesh 122, for example, is placed against the surface of polymer membrane layer 112. As feed solution fluid 124 is transferred through polymer membrane layer 112, and impurities are rejected at polymer membrane layer 112, filtrate fluid 126 is transferred to separate permeate carrier 120. In practice, this membrane assembly is sealed around permeate carrier 120 by adhesive to avoid loss of the clean solution, and then the flat envelopes are rolled around a center tube where the clean product water enters and is collected in a membrane element housing.

In an example embodiment of the present invention shown in FIG. 4, composite membrane sheet 130 comprises spacer features 136 applied to polymer layer 138 via interfacial polymerization in the same or similar chemical process as polymer layer 138 was constructed. Polyamide spacers 136 can be applied, as examples, by spraying, electrospraying, or printing directly on membrane polyamide layer 138. Polyamide spacers 136 can be printed with features such as those taught by Arnush, et al., or Maruf, et al. Polyamide spacers 136 can also comprise anti-fouling biocides as taught by Bradford, et al. In an example embodiment, polyamide layer 138 can be applied on to polysulfone layer 132. Polysulfone layer 132 is typically applied to a polyethylene support layer 134.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

We claim:

1. An element for use in a fluid filtration system, comprising:
(a) a support layer;
(b) an active layer, disposed on a first surface of the support layer;
(c) one or more spacing features, disposed on a surface of the active layer opposite the support layer;
wherein the one or more spacing features comprises a polymer.

2. The element of claim 1, wherein the polymer comprises polyamide.

3. The element of claim 1, wherein the active layer comprises polyamide.

4. A method of producing spacing features, comprising:
(a) providing a membrane comprising an active layer;
(b) disposing one or more spacing features comprising a polymer on a surface of the active layer.

5. The method of claim 4, wherein the interfacial polymerization is used to dispose a polymer on a surface of an active layer.

6. The method of claim 4, wherein the polymer comprises polyamide.

7. The method of claim 4, wherein the active layer comprises polyamide.

8. The method of claim 4, wherein disposing one or more spacing features comprises spraying, electrospraying, or printing on the active layer.

9. The method of claim 4, wherein disposing one or more spacing features comprises disposing the spacing features without applying heat or other energy to the spacing features or the active layer.
